(19) United States
(12) Patent Application Publication
(10) Pub. No.: US 2022/0278538 A1
(43) Pub. Date: Sep. 1, 2022

(54) CHARGING SYSTEM, CHARGING APPARATUS, MOBILE DEVICE AND INSERTION PORTION FOR A MOBILE DEVICE

(71) Applicant: Rosenberger Hochfrequenztechnik GmbH & Co. KG, Fridolfing (DE)

(72) Inventors: Christian Kainzmaier, Haiming (DE); Markus Schichl, Seekirchen (AT); Toni Scheuerlein, Eggenfelden (DE); Folke Michelmann, Tittmoning (DE); Benedikt Sanftl, Riedering (DE); Niklas Voelker, Muenchen (DE); Timo Bunk, Sauerlach (DE); Simon Huber, Engelsberg (DE)

(21) Appl. No.: 17/630,796

(22) PCT Filed: Aug. 5, 2020
(86) PCT No.: PCT/EP2020/072060

§ 371 Date: Jan. 27, 2022

(30) Foreign Application Priority Data
Aug. 8, 2019 (DE) 10 2019 121 430.0
Feb. 25, 2020 (DE) 10 2020 104 832.7

(51) Int. Cl. H02J 7/00; H01M 10/44

(52) U.S. Cl. CPC H02J 7/0045; H02J 7/00034; H01M 10/44; H01M 2220/20

(57) ABSTRACT

The invention relates to a charging system (1) comprising a mobile electrical device (2) and a charging apparatus (3) for charging a battery pack (7) of the mobile device (2) and/or for transmitting data between the charging apparatus (3) and the mobile device (2). The charging apparatus (3) has an insertion opening (9) for inserting an insertion portion (10) of the mobile device (2) into a charging tray (11) of the charging apparatus (3) in order to establish an electrical connection between the charging apparatus (3) and the mobile device (2). According to the invention, the charging tray (11) tapers from the insertion opening (9) in order to orient the insertion portion (10) of the mobile device (2) in the charging tray (11) during insertion.

The invention relates to a charging system, comprising a mobile electrical device and a charging apparatus for charging a rechargeable battery pack of the mobile device and/or for transferring data between the charging apparatus and the mobile device, as claimed in the preamble of claim 1.

The invention additionally relates to a mobile device, in particular an aircraft. Furthermore, the invention relates to a charging foot for a mobile device.

The invention also relates to a charging apparatus for charging a rechargeable battery pack of a mobile device and/or for transferring data between the charging apparatus and the mobile device, as claimed in the preamble of claim 30.

The invention further relates to an insertion portion for a mobile device, in particular for an aircraft.

Finally, the invention also relates to a charging method for charging a mobile electrical device in a charging apparatus, and to an advantageous use of a charging apparatus.

There is an increasingly need for mobile devices, in particular aircraft, to be allowed to act autonomously to the greatest possible extent. By way of example, unmanned aircraft (also known colloquially by the designation “drone”) can be used for cartography, surveillance and even for parcel delivery.

Corresponding fields of use necessitate charging the rechargeable battery packs of the mobile devices or of the aircraft at regular intervals. For this purpose, the aircraft can head for charging apparatuses of a static or mobile ground station and firstly land in as accurately targeted a manner as possible in spatial proximity to the charging apparatus. Subsequently, the charging process and optionally also an exchange of data can take place.

In this case, ultimately establishing the electrical connection between the charging apparatus and the aircraft is generally an obstacle to fully autonomous operation of the aircraft since a sufficiently accurate orientation or positioning cannot be reliably guaranteed during an aircraft landing process. An electrical lead or an electrical cable of the charging apparatus thus usually has to be manually connected to the aircraft.

Consequently, what is problematic when establishing the electrical connection between the charging apparatus and the mobile device is, in particular, the comparatively inaccurate positioning or orientation of the mobile device on the charging apparatus, for example owing to a landing process under adverse conditions (e.g. wind).

It is accordingly desirable to enable the mobile device or the aircraft to orient itself independently on the charging apparatus and to automatically establish the electrical connection.

To that end, it is known for electrical contact elements of the charging apparatus to be arranged in a manner distributed in a grid-shape fashion on a charging pad or on a charging surface. In this case, the charging surface is large enough that the aircraft can definitely land on it. However, in order that the aircraft subsequently also actually makes contact with the correct or envisaged contact elements of the grid, gripping arms or some other mechanical actuator system are or is finally required in order to displace the aircraft into the correct position.

This solution is comparatively complex, however.

In view of the known prior art, the object of the present invention consists in providing an improved charging system in which the electrical connection between a mobile device and a charging apparatus can be established preferably as autonomously as possible.

Finally, it is also an object of the invention to provide a mobile electrical device which is able to establish an electrical connection to a charging apparatus preferably as autonomously as possible. Furthermore, it is an object of the invention to provide an improved charging foot for a mobile device.

Moreover, it is an object of the invention to provide an improved charging apparatus which is able to establish an electrical connection to a mobile electrical device preferably as autonomously as possible.

It is also an object of the invention to provide an insertion portion for a mobile electrical device which enables the mobile device to establish an electrical connection to a charging apparatus preferably as autonomously as possible.

Finally, it is an object of the invention to provide an advantageous charging method and an advantageous use of a charging apparatus.

The object is achieved for the charging system by means of the features presented in claim 1. The object is achieved by means of the features of claim 28 with regard to the mobile electrical device and by means of claim 29 for the charging foot. The object is achieved by means of claim 30 regarding the charging apparatus and by means of claim 31 for the insertion portion. The object is achieved by means of claim 32 regarding the charging method and by means of claim 34 for the use.

The dependent claims and the features described below relate to advantageous embodiments and variants of the invention.

A charging system is provided, comprising a mobile electrical device and a charging apparatus for charging a rechargeable battery pack of the mobile device and/or for transferring data between the charging apparatus and the mobile device.

In the context of the charging system, in particular exclusive charging of a rechargeable battery pack of the mobile device, an exclusive transfer of data between the charging apparatus and the mobile device (where the term “charging system” and respectively “charging apparatus” in this case should be understood rather in an abstract way) or a combined transfer of data with simultaneous charging of the rechargeable battery pack can be provided.

The data to be transferred can be analog and/or digital data. By way of example, there can be data which the mobile device has gathered previously (for example image and/or sound recordings from a drone or a cellular phone). However, the data can also be data of a battery management system (BMS) of the rechargeable battery pack, which battery management system will also be mentioned below. In principle, any desired data can be transferred.

The data, proceeding from the charging apparatus, can also be forwarded to an independent electrical assembly (e.g. the independent controller also mentioned below), for example forwarded directly to a wired or wirelessly connected electrical assembly (in unprocessed form or after been processed, e.g. filtered, sampled, subjected to analog/digital conversion, subjected to digital/analog conversion, etc.). Conversely, too, data of an independent electrical assembly can be forwarded directly to the mobile device via the charging apparatus (in unprocessed form or after having been processed). Provision can also be made for buffer-storing the data in the charging apparatus for a later further transfer to the mobile device and/or the independent electrical assembly.

A rechargeable battery pack is taken to mean a rechargeable energy storage unit, which can be either a rechargeable battery having a single rechargeable battery cell (also called “secondary cell”) or an interconnected pack having a plurality of rechargeable battery cells. A rechargeable battery pack can also be taken to mean a storage unit for electrical energy which is not or not exclusively constructed on an electrochemical basis, i.e. a capacitor, for example.

Provision can be made for at least one of the rechargeable battery packs used to be a lithium-based rechargeable battery pack, in particular a lithium-ion rechargeable battery pack or a lithium-polymer rechargeable battery pack. However, the rechargeable battery pack can also be a nickel-metal hybrid rechargeable battery, a nickel-cadmium rechargeable battery or a lead-acid rechargeable battery. In principle, the invention should be understood as not being limited to the use with a specific type of rechargeable battery pack.

If the invention is used only for transferring data, within the meaning of the invention a “rechargeable battery pack” can also be a battery or a battery pack, i.e. a non-rechargeable storage unit for electrical energy.

The electrical device also need not necessarily comprise a rechargeable battery pack, particularly if no charging but rather only a data transfer is provided. The mobile electrical device can obtain its electrical energy for example also in a wired fashion, capacitively and/or inductively (e.g. from the charging apparatus or some other electrical apparatus).

The invention provides for the charging apparatus to have an insertion opening for inserting an insertion portion of the mobile device into a charging cradle of the charging apparatus in order to establish an electrical connection between the charging apparatus and the mobile device.

Provision is thus made for inserting the mobile device into the charging cradle proceeding from the insertion opening.

The mobile device can be inserted into the charging cradle completely or else only in portions (for example only by its insertion portion). Preferably, the insertion portion of the mobile device is completely inserted into the charging cradle after the process of insertion according to the invention. However, provision can also be made for even the insertion portion to be only partly inserted into the charging cradle.

The invention provides for the charging cradle to taper proceeding from the insertion opening in order to orient the insertion portion of the mobile device (or the mobile device) during insertion in the charging cradle.

The charging cradle can thus taper in the direction of a lower end or an underside proceeding from an upper end or a top side (insertion opening).

The taper in the charging cradle can advantageously result in a self-orientation of the insertion portion and thus of the mobile device. Inaccuracies when inserting the insertion portion of the mobile electrical device (e.g. a tilting, a rotation and/or a lateral offset) can be compensated for according to the invention on the basis of the taper of the charging cradle.

The charging system according to the invention can advantageously be used to establish an electrical connection between the mobile device and the charging apparatus in an autonomous manner. Provision can also be made for the charging system to support autonomous operation by virtue of its providing a platform, in particular the charging cradle mentioned, for an autonomous charging process and/or for a data transfer.

In the context of the invention, an ‘orientation’ should be understood to mean a defined, predetermined positioning, orienting and/or inclination of the insertion portion or of the mobile device in the charging cradle. In particular, a defined rotation angle, a defined tilt angle and/or a defined position of the insertion portion or of the mobile device relative to a center axis of the charging cradle can be predefined for the mobile device by the taper. Preferably, the mobile device is centered in the charging cradle and/or oriented parallel to a center axis of the charging cradle.

Provision can be made for the charging cradle to taper linearly, to taper concavely and/or to taper convexly. In principle, the taper can follow any desired curve.

In an advantageous manner, on account of the—according to the invention—robust and reliable contact-making between the mobile device and the charging apparatus it is possible to safety transfer currents of one ampere or more, for example 5 amperes or more. 10 amperes or more, preferably 20 amperes or more, particularly preferably 50 amperes or more, very particularly preferably 100 amperes or more, for example also 150 amperes or even more. The current intensity is preferably only limited by the permissible currents of the rechargeable battery pack or of the energy storage unit. The transfer of high-frequency data signals (or other data signals) can also be effected advantageously and reliably on account of the contact-making according to the invention.

In one advantageous development of the invention, provision can be made for the mobile electrical device to be an aircraft, in particular an unmanned aircraft.

An aircraft should be understood to mean in particular a vehicle that is able to fly within the Earth's atmosphere, i.e. in particular below an altitude of approximately 100 km. The invention is particularly advantageously suitable for use with a rotorcraft, for example a helicopter. The invention is very particularly preferably suitable for use with an aircraft having a plurality of propellers (also referred to as rotors or airscrews), for example a quadcopter.

In the context of the invention, an unmanned aircraft should be understood to mean an aircraft which, without any crew onboard, can be operated and navigated autonomously by a computer or by a user via a remote control. Such aircraft are also known by the designations “unmanned aerial vehicle, UAV”, “unmanned aircraft system, UAS” and also colloquially by the terms “drone” and “copter”.

Consequently, a plug-in system for the autonomous electrical connection of “drones” for the purpose of charging and/or for the purpose of data transfer can advantageously be provided.

The invention is particularly preferably suitable for use with an (unmanned) aircraft in particular since a landing operation, particularly if the latter takes place under adverse ambient conditions such as rain and/or wind, is extremely complex. The orientation or positioning of the aircraft during the landing operation is subject to great tolerances—even if the aircraft is computer-controlled. For this reason, automatic establishment of a data and/or charging connection is generally not possible or at least cannot always be guaranteed. According to the invention, by contrast, the landing can take place comparatively inaccurately as long as the aircraft does not totally miss the insertion opening. The insertion opening can be made sufficiently large for this purpose.

In principle, however, the invention is also suitable for use with arbitrary other vehicles, in particular unmanned vehicles on land or in water. The invention is also suitable, if appropriate, for use with spacecraft.

Furthermore, the invention is advantageously suitable for use with mobile terminals such as cellular phones or smartphones or tablet computers. In this case, the charging apparatus can advantageously form a so-called docking station for the mobile terminal, into which the mobile terminal can be inserted or introduced through the insertion opening even with a decreasing degree of attention or with reduced care on the part of the user, after which a required orientation and subsequently the charging process and/or the exchange of data can be effected automatically.

The invention can for example also be highly suitable for the return of rented mobile devices in the context of a rental system. In this case, the customer can return the mobile device after use thereof by introducing or putting said mobile device into the charging cradle through the insertion opening. The mobile device can then be identified, inter alia, in order to log the return thereof, personal data can then be removed from it and finally it can be charged.

Many further fields of application for which the invention can advantageously be suitable are also possible as well.

The invention is described below substantially for use with a mobile device embodied as an aircraft. This is intended merely to facilitate simpler understanding and should in no way be understood as restrictive.

In accordance with one development of the invention, provision can be made for the charging cradle to have one side wall tapering conically proceeding from the insertion opening or a plurality of side walls, preferably four side walls, tapering pyramidally proceeding from the insertion opening.

The side wall or the side walls can preferably be arranged in a manner extending completely circumferentially around the charging cradle. However, the side wall or the side walls can also have openings or be segmented/interrupted. In this case, the side wall segments preferably form the corners of the pyramidally tapering charging cradle.

Preferably, however, the side wall or the side walls of the charging cradle form(s) a completely circumferentially extending, funnel-shaped insertion region proceeding from the insertion opening.

If the charging cradle has only one side wall tapering conically, the charging cradle can preferably form a hollow truncated cone, the base surface of which has the insertion opening. If the charging cradle has a plurality of side walls tapering pyramidally, the charging cradle can preferably form a hollow truncated pyramid, the base surface of which forms the insertion opening.

Although preferably either one side wall or particularly preferably four side walls is or are provided, three side walls tapering pyramidally proceeding from the insertion opening or else more than four side walls, for example five, six, seven, eight or even more side walls tapering pyramidally proceeding from the insertion opening, can also be provided.

In one particularly preferred development of the invention, provision can be made for the charging cradle to have a plurality of side wall segments forming respective corners of the charging cradle.

Preferably, exactly four side wall segments can be provided. However, it is also possible for only two or three side wall segments to be provided. The use of more than four side wall segments is also possible in the context of the invention.

In accordance with one development of the invention, provision can be made, in particular, for the side wall segments to taper conically proceeding from the insertion opening.

In order to establish the electrical connection, the charging cradle can have electrical contact elements. The insertion portion of the mobile device can have corresponding mating contact elements.

Provision can also be made for the electrical connection to be embodied as a contactless or radio-based connection, wherein contact elements and respectively mating contact elements can be dispensed with.

A combination of a contact-based and a contactless electrical data and/or charging connection can also be provided. By way of example, provision can be made for a contact-based charging process to be carried out in addition to a contactless data transfer—or vice versa. Provision can be made of an arbitrary radio standard for forming the contactless or radio-based data transfer. By way of example, a Bluetooth standard, a WLAN standard, a ZigBee standard or some other radio standard, in particular within the ISM band, can be provided. An RFID system can also be provided. A contactless charging connection can be embodied for example capacitively or preferably inductively.

Preferably, however, provision is made of a contact-based charging and/or data connection using contact elements and mating contact elements.

In accordance with one development of the invention, provision can be made for the charging cradle and the insertion portion to form electrical contact element pairs comprising in each case a contact element of the charging cradle and a corresponding mating contact element of the insertion portion.

In principle, any desired number of contact element pairs can be provided, preferably two or more contact element pairs, particularly preferably three or more contact element pairs, very particularly preferably four contact element pairs, but also for example five, six, seven, eight, nine, ten or even more contact element pairs.

A respective contact element of the charging cradle and a mating contact element of the insertion portion can be embodied and arranged in particular for establishing an electrical connection to one another when the insertion portion of the mobile device is inserted into the charging cradle as far as its envisaged end position and is oriented according to the invention in the charging cradle.

In particular, a high number of contact element pairs for transferring high currents can be advantageous if the charging task or the current transfer is distributed among a plurality of contact element pairs. A multiplicity of contact element pairs can additionally be suitable for forming a parallel data bus.

A contact element and/or mating contact element can be embodied from copper, for example. Copper has proved to be particularly suitable on account of good sliding properties. In principle, however, other materials (e.g. graphite), but in particular metals/metal alloys (e.g. brass), are also possible for forming the contact element and/or the mating contact element.

The contact elements can be embodied as coplanar with the side wall or the side walls of the charging cradle. The mating contact elements can be embodied as coplanar with the insertion portion, in particular with the side surfaces—also mentioned below—of the charging feet.

Provision can also be made of conductive surfaces for forming the contact elements and/or mating contact elements. By way of example, provision can be made for the side wall or the side walls of the charging cradle to be embodied as completely conductive or conductive in portions. Provision can also be made for the side surfaces—also mentioned below—of the charging feet to be embodied as completely conductive or conductive in portions.

The contact elements and/or mating contact elements can be embodied in monolayered or multilayered fashion. By way of example, it is possible to form a multilayered contact element or mating contact element e.g. made from brass with an electroplated surface made from nickel or gold.

In one development of the invention, provision can be made for the contact element and/or the mating contact element of at least one of the contact element pairs to be embodied as flat contact, spring contact (e.g. spring contact pin) and/or magnetically mounted contact.

In particular, combinations of different types of contact can be highly suitable for forming a contact element pair.

In one preferred variant of the invention, provision can be made for a contact element of a contact element pair to be embodied as a flat contact, in particular as a strip contact or sliding contact, and for the corresponding mating contact element to be embodied as a spring-mounted contact, in particular as a spring contact pin or leaf spring contact.

In one development of the invention, provision can be made for the contact elements of the charging cradle to be arranged on the side wall(s) or on the side wall segments.

An arrangement of the contact elements of the charging cradle on the side walls or on the side wall segments has proved to be particularly suitable since the side walls or side wall segments can serve for orienting the insertion portion or the mobile device and as a result the mobile device is correspondingly supported on the side walls or side wall segments. As a result, the electrical contact between the contact element and the correspondingly mating contact element can be improved, for example can be more vibration-proof and in principle more robust.

Alternatively or additionally, provision can also be made for the contact elements of the charging cradle to be arranged on a charging surface facing the insertion opening. The mobile device can thus be inserted into the charging cradle proceeding from the insertion opening and can be oriented until at least one of the mating contact elements of the mobile device is placed on one or more charging surfaces and the mobile device thereby makes contact with a contact element of the charging cradle.

In one advantageous development of the invention, provision can be made for the contact elements of the charging cradle to be arranged in a manner adjoining corners of two converging side walls or in a manner adjoining the corners of the side wall segments, wherein preferably two contact elements are assigned to each corner.

Preferably, the contact elements are separated from one another by the corner, as a result of which for example each side wall in the region of each corner has a dedicated contact element (or a plurality of contact elements). However, provision can also be made for a single contact element, proceeding from a side wall, to extend by way of the corner as far as the adjoining side wall, as a result of which the contact element ultimately itself forms the corner.

Particularly preferably, the charging cradle is embodied as a pyramidally tapering charging cradle having exactly four side walls and exactly four corners, wherein each of the corners preferably has two or more contact elements. A likewise preferred charging cradle has exactly four side wall segments each having exactly one corner, wherein each of the corners preferably has two or more contact elements.

However, provision can also be made for one or more corners to have no contact element or to have merely one or a plurality of dummy contact elements that are not used electrically.

Furthermore, provision can be made to the effect that, in a corner, also merely only a single contact element is provided on one of the two side walls forming the corner.

In accordance with one development of the invention, provision can be made for the side wall segments to be arranged displaceably in the charging apparatus in order to embody the charging cradle adaptably for inserting different mobile devices.

The charging cradle can thus be adaptable for receiving arbitrary mobile devices, for example aircraft. In particular, the size and/or the geometry of the charging cradle or of the insertion opening of the charging cradle can be adaptable by displacement of the side wall segments in order to adapt the charging cradle to a specific size and/or geometry of the insertion portion of the mobile device.

Preferably, the charging apparatus is embodied to enable an automatic or automated adaptation of the charging cradle.

Optionally, the charging apparatus can be configured to identify an approaching mobile device and/or to recognize the orientation thereof in order to corresponding adapt the charging cradle. This can be effected for example optically, for example by means of optical sign generators or optical markers present on the mobile device, or by means of the communication connection—also described below—between the charging apparatus and the mobile device.

In one development of the invention, provision can be made for each of the side wan segments to be displaceably connected to a guide rail, wherein the guide rails are arranged in a cruciform fashion or in a star-shaped fashion around the center axis of the charging cradle.

Preferably, each side wall segment is assigned to a dedicated guide rail. However, it is also possible for a plurality of side wall segments to be assigned to the same guide rail, in particular side wall segments situated opposite one another in relation to the center axis of the charging cradle.

The side wall segments, in each case individually, in groups or jointly (in a coupled movement) can be conveyable in the direction toward the center axis of the charging cradle or can be movable away from the center axis in order either to decrease or to increase the size of the insertion opening of the charging cradle.

Provision can be made for the charging cradle to have electrical, acoustic and/or optical signal generators or markers in order additionally to support autonomous insertion of the mobile device or the insertion portion thereof into the charging cradle. Preferably, provision is made of illuminants, for example a light-emitting diode in each of the corners of the charging cradle, in order to support a computer-aided, visually based landing of an unmanned aircraft.

In one development of the invention, provision can be made for the insertion portion of the mobile device to have a completely circumferentially extending frame or a frame segment.

By way of example, a completely circumferentially extending ring or a ring segment can be provided. However, an angular frame, for example a rectangle or square frame, or corresponding frame segments, can also be provided.

A corresponding frame or a frame segment is able to support the insertion of the insertion portion, if appropriate, particularly if the frame or the frame segment is geometrically adapted to the charging cradle (or vice versa).

However, such a frame also involves the disadvantage of increased weight and increased costs. Moreover, it is generally difficult to secure the frame to the mobile device. By way of example, a circumferentially extending frame may possibly restrict the field of view of a camera system of the mobile device, for example of an aircraft.

In one particularly advantageous development of the invention, provision can be made for the insertion portion of the mobile device to have three or more charging feet, preferably four charging feet or more charging feet.

The inventors have surprisingly recognized that in particular the use of individual charging feet can result in an improved self-centering of the mobile device in the charging cradle. Furthermore, the mounting of individual charging feet is possible more flexibly than would be the case for a completely circumferentially extending frame or for frame segments.

The charging feet preferably undertake part of the orientation task and are accordingly embodied as solid or robust enough not to be damaged to themselves by frequent insertion of the mobile device into the charging cradle. Preferably, a charging foot within the meaning of the invention is not a contact wire.

The number of charging feet can be arbitrary, in principle; by way of example, five charging feet or more charging feet, six charging feet or more charging feet, seven charging feet or more charging feet, eight charging feet or even more charging feet can also be provided.

Preferably, the number of charging feet of the insertion portion of the mobile device corresponds to the number of side walls or side wall segments of the charging cradle or to the number of corners formed by the side walls.

In one advantageous development of the invention, provision can be made for the charging feet to be angled along an insertion angle or to have a contact portion angled along an insertion angle, wherein the insertion angle preferably corresponds to a taper angle according to which the charging cradle tapers.

Preferably, the insertion angle of the charging feet is adjustable.

By way of example, an insertion angle of 20° to 70° can be provided, preferably an insertion angle of 30° to 60°, particularly preferably of 45′.

The use of a corresponding insertion angle has proven to be suitable in order to orient the mobile device or the insertion portion thereof even more advantageously within the tapering charging cradle.

Furthermore, the distribution of forces and thus the contact force of a contact element pair can also be set advantageously by the insertion angle.

The angle along which the charging cradle tapers can preferably correspond to the insertion angle of the charging feet.

Provision can be made for the angle along which the charging cradle tapers to be adjustable. In particular, the angle can be adjusted particularly advantageously with the use of side wall segments. As a result, the angle along which the charging cradle tapers can be optimally adaptable if appropriate for different charging feet.

In one development of the invention, provision can be made for at least one of the mating contact elements to be arranged, preferably two of the mating contact elements to be arranged, on at least one of the charging feet.

In principle, any desired number of mating contact elements can be arranged on a charging foot, for example also only one mating contact element, three or more mating contact elements, four or more mating contact elements, five or more mating contact elements, or six or even more mating contact elements.

The charging feet can each have a carrier structure in order to secure the charging feet to the mobile device. The carrier structure can be for example a clamping ring for securing to a structural profile, for example an empty tube, of the mobile device. The carrier structure can be embodied for example from a metal, a metal alloy and/or a plastic. Preferably, the carrier structure is not the mating contact element.

The charging feet can each have one or more functional surfaces for securing the mating contact elements. The functional surface(s) together with the mating contact element(s) can form the angled contact portion. The functional surface(s) can be secured to the carrier structure or can be embodied integrally with the carrier structure.

Provision can also be made for one charging foot or a plurality of charging feet to have no mating contact element or to have one or a plurality of dummy mating contact elements that are not used electrically. The term “charging foot” in this case should be understood rather in an abstract way, to the effect that the charging feet can advantageously be suitable for orienting and ultimately for charging the mobile device in the charging cradle.

In one development of the invention, provision can be made for two mating contact elements to be arranged in a manner adjoining an edge of two converging side surfaces of the charging feet, wherein preferably one of the mating contact elements is assigned to each of the two side surfaces. The side surfaces can be the functional surfaces mentioned above.

This variant of the invention is suitable in particular for embodying contact element pairs having contact elements assigned to corners of the charging cradle. The edge or the edges of the insertion portion of the mobile device can thus advantageously engage in the corners of the charging cradle and thereby make contact with the contact elements in an accurately targeted manner when the insertion portion is oriented in the charging cradle.

In accordance with one development of the invention, provision can be made for the charging feet to be embodied as extendable or retractable.

The charging feet can for example themselves be extendable or retractable or be mounted on an extendable or retractable mount, e.g. a telescopic rod. The charging feet can be telescopic, for example.

Provision can preferably also be made for arranging a contact portion of a charging foot on a rod or on a tube or on some other structural profile displaceably and fixably or clampably by means of a screw, for example.

By virtue of the fact that the charging feet are embodied as extendable or retractable, the invention can advantageously be adapted in a simple manner for use with different mobile devices or aircraft. Preferably, a modular charging system can be provided. In principle, the charging feet can also be mounted only in a static fashion.

Provision can be made for the charging feet to be spring-mounted or mounted at least partly elastically in some other way, in order to reduce the mechanical loading of the mobile device and/or of the charging feet and/or charging cradle during the insertion of the insertion portion into the charging cradle.

In one advantageous development of the invention, provision can be made for the charging feet to be arranged on a landing gear and/or on cantilevers for securing propellers of an aircraft.

The charging feet can project vertically downward for example proceeding from the landing gear of an aircraft. However, the charging feet can also be secured to “horizontal” carriers parallel to the cantilevers of the propellers. Provision can also be made for mounting the charging feet on the electric motors, on the propeller securing means or on an arbitrary frame component of the aircraft, for example on the chassis of the vehicle (or of the mobile device). In principle, there are diverse possibilities for securing the charging feet, for which reason the invention can particularly advantageously be highly suitable for use with different mobile devices, in particular with different unmanned aircraft.

Provision can be made for the charging cradle and/or the charging feet or the insertion portion to have means for reducing the friction during the insertion of the insertion portion into the charging cradle. By way of example, provision can be made for providing rollers or skids on the charging feet and/or rollers on the inner side of the charging cradle. The rollers or skids can optionally simultaneously form the contact elements and/or mating contact elements.

In one advantageous development of the invention, provision can be made for the charging cradle to have a cutout situated opposite the insertion opening.

By way of example, the charging cradle can consist exclusively of the one or the plurality of side walls that are open toward the “top” and toward the “bottom”.

A cutout on the underside or on the side of the charging cradle situated opposite the insertion opening can be advantageous for guiding downwardly projecting parts of the mobile device (for example a cantilever for a camera or a gripper) through said cutout and/or for being able to divert liquids, for example rainwater, out of the charging cradle.

In one development of the invention, provision can be made for the charging apparatus to have a rotation unit in order to set the rotational position of the charging cradle.

As a result, the orientation or rotational position of the charging cradle can be flexibly adaptable to the orientation of the mobile device. As a result, a coarse positioning can be effected by means of the charging cradle, wherein the fine positioning can subsequently be effected by means of the interaction according to the invention between the charging cradle and the insertion portion of the mobile device. In principle, supplementarily or alternatively, however, provision can also be made for the mobile device to adapt its orientation to the rotational position of the charging cradle.

In one preferred development of the invention, provision can be made for the rotation unit to have a rotary disk, which carries the side walls or the side wall segments and is rotatable about the center axis of the charging cradle.

The rotary disk can be connected to the rotor of an electric motor, for example, as a result of which an automatic adaptation of the rotational position of the charging cradle becomes possible. In principle, however, a manually rotatable rotary disk can also be provided.

Provision can additionally be made for the rotary disk to be mounted freely rotatably during the insertion of the mobile device. As a result, the insertion of the mobile device can be improved further, if appropriate, since the charging cradle can perform a compensating rotational movement during the insertion of the mobile device. However, the rotary disk can also be mechanically fixed during the insertion of the mobile device in order to maintain a defined rotational position of the charging cradle.

In accordance with one development of the invention, provision can be made for the charging apparatus and/or the mobile device and/or at least one of the charging feet to have a controller for controlling the charging process.

Provision can also be made of a controller which is independent of the mobile device or the charging apparatus and which can be connected as necessary to the mobile device or preferably to the charging apparatus, for example via a plug connection.

The controller can be embodied as a microprocessor. Instead of a microprocessor, it is also possible to provide any further apparatus for implementing the controller, for example one or more arrangements of discrete electrical components on a printed circuit board, a programmable logic controller (PLC), an application-specific integrated circuit (ASIC) or some other programmable circuit, for example also a field programmable gate array (FPGA), a programmable logic array (PLA) and/or a commercially available computer.

The controller of the mobile device can preferably be a controller which controls even further functions of the mobile device. By way of example, the controller of the mobile device can be a flight controller of an unmanned aircraft.

Preferably, the mobile device comprises a first controller and the charging apparatus comprises a second controller. The second controller can also be independent of the charging apparatus and be connected to the charging apparatus via a plug connection, for example.

In one advantageous development of the invention, provision can be made for the controller to be configured to detect a correct electrical connection between the mobile device and the charging cradle, wherein the controller is furthermore configured to initiate the charging process and/or the data transfer only in the case of the correct electrical connection.

By way of example, sensors can be provided in order to identify the correct orientation or the correct connection of the contact element pairs. In particular, it is also possible to provide test signals having low or safety-non-critical current intensities or low voltages in order to identify a correct electrical connection.

In particular, provision can be made for initiating a charging process only in the case of a correct electric connection of all contact element pairs. Particularly preferably, for example a charging voltage can be present at the contact elements of the charging apparatus only when the contact elements are connected to the corresponding mating contact elements. Short circuits and thus also endangerment of objects and/or persons by the exposed contact elements can be avoided as a result.

Provision can also be made for the contact elements and/or the mating contact elements to be configured mechanically to initiate the charging process and/or the data transfer only in the case of the correct electrical connection. For this purpose, provision can be made, for example, for the contact elements and/or the mating contact elements to comprise encoded magnets and/or spring elements in order to establish an electrical connection only in the case of correct contact-making, for example by means of magnetic conveyance of a power slide.

Provision can also be made for the charging apparatus and/or the mobile electrical device to comprise a safety circuit in order to preclude short circuits on account of erroneously oriented contact elements and/or mating contact elements.

In one advantageous development of the invention, provision can be made for the controller of the charging apparatus (or the independent controller) to be configured to exchange electrical data signals for controlling the charging process with a battery management system (BMS) of the rechargeable battery pack.

A modern rechargeable battery pack usually comprises an integrated battery management system. The BMS serves for monitoring and/or regulation of the rechargeable battery pack (in some instances also referred to as “power management system” (PMS)) and transfers data about the state (for example state of charge and/or temperature status) and/or design or characteristic parameters (e.g. rated voltage, end-of-charge voltage and/or identification data) of the respective rechargeable battery pack usually in an analog and/or digital manner.

The transfer of data between the charging apparatus and the battery management system of the rechargeable battery pack of the mobile device can thus be advantageous in particular for controlling the charging process.

In one development of the invention, provision can be made for the controller of the charging apparatus to be configured to exchange data for the identification of the mobile device and/or for the acquisition of movement data of the mobile device, in particular position, orientation and/or tilt angle, wirelessly with the controller of the mobile device and/or with the controller of one of the charging feet.

Particularly preferably, provision is made of a wireless communication connection between the controller of the charging apparatus and the controller of at least one of the charging feet.

In one advantageous development of the invention, provision can be made for the controller of the charging foot to be communicatively connected to the controller of the mobile device for the exchange of data. The controller of the charging foot can be connected to the controller of the mobile device for example wirelessly or in a wired manner.

The controller of at least one of the charging feet can be configured in particular as a mediator between the controller of the charging apparatus and the controller of the mobile device. The charging system can thus be adaptable overall more modularly or to different mobile devices, without appreciably intervening in the controller or electronics of the mobile device.

In one advantageous development of the invention, provision can be made for the controller of the charging foot to be configured to read out movement data of the mobile device from the controller of the mobile device and/or to communicate instructions for maneuvers to be carried out by the mobile device to the controller of the mobile device.

The controller of the charging foot can be configured for example to use specific, predefined control signals for the communication with the mobile device. By way of example, provision can be made for the controller of the charging foot to emulate control signals of a remote control or for the controller of the charging foot to be connected to the controller of the mobile device via an already present programming interface of the mobile device.

The controller of the charging foot can be configured for example to communicate to the controller of a mobile device embodied as an aircraft a signal for carrying out a landing approach or a change in the rotational position, wherein the controller of the charging foot can optionally be caused to pass on the control signals by the controller of the charging apparatus. Consequently, the charging apparatus can undertake for example the supervision of the aircraft during the insertion of the insertion portion into the insertion opening.

The invention also relates to a mobile device, in particular an aircraft, for a charging system in accordance with the embodiments above and below.

A mobile device, in particular an aircraft, can advantageously be provided which can charge itself autonomously or independently at a corresponding charging apparatus and/or can exchange data with the charging apparatus. A manual user intervention can be obviated as a result.

The mobile device can for example also be a land vehicle, a spacecraft or a watercraft.

Particularly (but not exclusively) if a watercraft is provided for operation on and/or under water, seals and/or lock systems can optionally be provided in order to protect the contact elements, the mating contact elements, electronic components, components at risk of corrosion or other components of the mobile device or of the charging apparatus against direct contact with water.

In order to bring the mobile device within the range of the charging apparatus for inserting the insertion portion into the charging cradle, provision can be made for the mobile device, in particular an aircraft, firstly to be guided manually or automatically to the charging apparatus until the insertion portion of the mobile device can be inserted into the insertion opening. Besides the markers already mentioned, an orienting using a global position determining system, for example GPS or Galileo, can also be provided for this purpose.

The invention also relates to a charging foot for a mobile device.

The invention additionally relates to a charging apparatus for charging a rechargeable battery pack of a mobile device and/or for transferring data between the charging apparatus and the mobile device. The charging apparatus comprises an insertion opening and a charging cradle, wherein an insertion portion of the mobile device is insertable into the charging cradle through the insertion opening in order to establish an electrical connection between the charging apparatus and the mobile device. Provision is made for the charging cradle to taper proceeding from the insertion opening in order to orient the insertion portion of the mobile device during insertion in the charging cradle.

The taper of the charging cradle enables the mobile device or the insertion portion thereof to orient itself in the charging cradle, without a manual intervention being required. The mobile device is preferably oriented solely by its weight force while its insertion portion penetrates continuously more deeply into the charging cradle.

As an alternative or in addition to a weight-force-based insertion of the mobile device into the charging cradle, provision can also be made for the mobile device to be inserted into the charging cradle by a propulsion caused by the mobile device and/or the charging cradle, i.e. in a drive-force-based manner. In this regard, the mobile device can be moved toward the charging cradle and/or the charging cradle can be moved toward the mobile device. A drive-force-based insertion of the mobile device can be highly suitable in particular for applications in water or in space.

By way of example, the mobile device can also be inserted into the charging cradle by a gripper of the charging apparatus or by a suction apparatus of the charging apparatus.

A universal charging apparatus can advantageously be provided in order to autonomously orient and charge different mobile devices, if appropriate with only slight adaptations of a corresponding insertion portion, in the charging apparatus.

The charging apparatus can optionally comprise a locking apparatus in order to lock a mobile device connected to the charging apparatus in the charging cradle.

In addition to charging and/or exchange of data, provision can also be made for the charging apparatus to exchange individual components of the mobile device (for example a rechargeable battery pack, a data memory or a deflective component), to remove cargo (e.g. soil samples or letter mail) from the mobile device or to add cargo (e.g. a parcel or letter mail to be delivered to a recipient) to the mobile device or to repair the mobile device.

The invention additionally relates to an insertion portion for a mobile device, in particular for an aircraft. The insertion portion is embodied for inserting the mobile device through an insertion opening into a charging cradle of a charging apparatus, said charging cradle tapering conically proceeding from the insertion opening, in such a way that the insertion portion orients itself in the charging cradle during insertion.

The insertion portion can be used in particular for the mechanical orientation of a drone or of an unmanned aircraft in the charging cradle of a charging apparatus.

The invention additionally relates to a charging method for charging a mobile electrical device in a charging apparatus, according to which the mobile device independently orients itself on account of the geometric shape of a charging cradle of the charging apparatus in combination with an insertion portion of the mobile device and thereby establishes an electrical connection between the charging apparatus and the mobile device. Subsequently a charging process or a data transfer between the charging apparatus and the mobile device can advantageously be initiated. The geometric shape of the charging cradle is preferably the tapering geometry that has already been described above.

In one advantageous development of the invention, provision can be made for the charging apparatus automatically to adapt the size of the charging cradle to a size of the mobile device and/or automatically to adapt a rotational position of the charging cradle to an orientation of the mobile device.

The invention also relates to an advantageous use of at least one charging apparatus of a charging system in accordance with the embodiments above and below, for providing a flight corridor for aircraft.

The charging apparatus(es) can be positioned for example in envisaged flight entry areas of unmanned aircraft in order to increase the range of the unmanned aircraft. In particular, it is possible to use a plurality of charging apparatuses for forming a longer flight corridor. By way of example, an advantageous infrastructure for parcel deliveries by unmanned aircraft can be made possible as a result.

The charging apparatuses can be provided in particular for the user-independent charging of mobile devices, in particular aircraft. By means of an identification of the mobile device, billing or invoicing for the charging process can subsequently be effected. The charging apparatuses can also be rented.

It goes without saying that features which have been described in association with the charging system according to the invention are also advantageously implementable for the mobile electrical device, the charging foot, the charging apparatus, the insertion portion of the mobile device or the charging method—and vice versa. Furthermore, advantages that have already been mentioned in associated with the charging system according to the invention can also be understood relative to the mobile electrical device, the charging foot, the charging apparatus, the insertion portion of the mobile device or the charging method—and vice versa.

It should additionally be pointed out that terms such as “comprising”, “having” or “with” do not exclude other features or steps. Furthermore, terms such as “a/an” or “the” indicating steps or features in the singular do not exclude a plurality of features or steps—and vice versa.

In a puristic embodiment of the invention, however, provision can also be made for the features introduced by the terms “comprising”, “having” or “with” in the invention to be enumerated exhaustively. Accordingly, one or a plurality of enumerations in the context of the invention can be considered to be self-contained, for example considered in each case for each claim. The invention can consist for example exclusively of the features mentioned in claim 1.

Furthermore, it should be emphasized that the values and parameters described in the present case concomitantly include deviations or variations of ±10% or less, preferably ±5% or less, more preferably ±1% or less, and very particular preferably ±0.1% or less, of the value or parameter respectively mentioned, provided that these deviations are not excluded in practice in the implementation of the invention. The specification of ranges by way of start and end values also encompasses all those values and fractions which are included by the range respectively mentioned, in particular the start and end values and a respective average value.

Exemplary embodiments of the invention are described in greater detail below with reference to the drawing.

The figures show in each case preferred exemplary embodiments in which individual features of the present invention are illustrated in combination with one another. Features of an exemplary embodiment are also implementable in isolation from the other features of the same exemplary embodiment and can accordingly be straightforwardly linked with features of other exemplary embodiments to form further expedient combinations and subcombinations by a person skilled in the art.

In the figures, functionally identical elements are provided with the same reference signs.

In the figures, schematically:

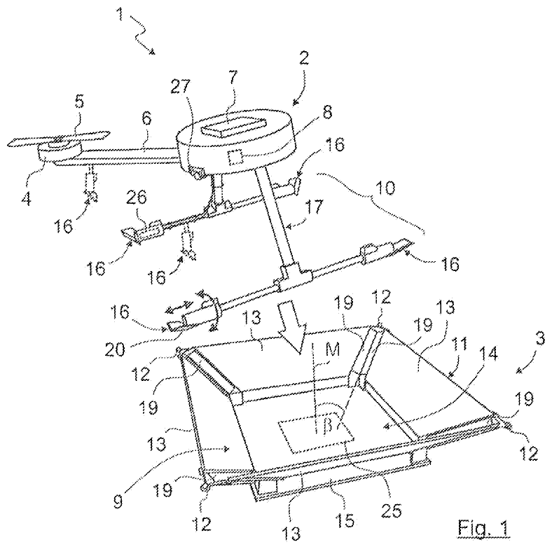

FIG. 1 shows a charging system with a charging apparatus and a mobile electrical device in a perspective illustration;

FIG. 2 shows a charging apparatus with a charging cradle in accordance with a second exemplary embodiment in a perspective illustration;

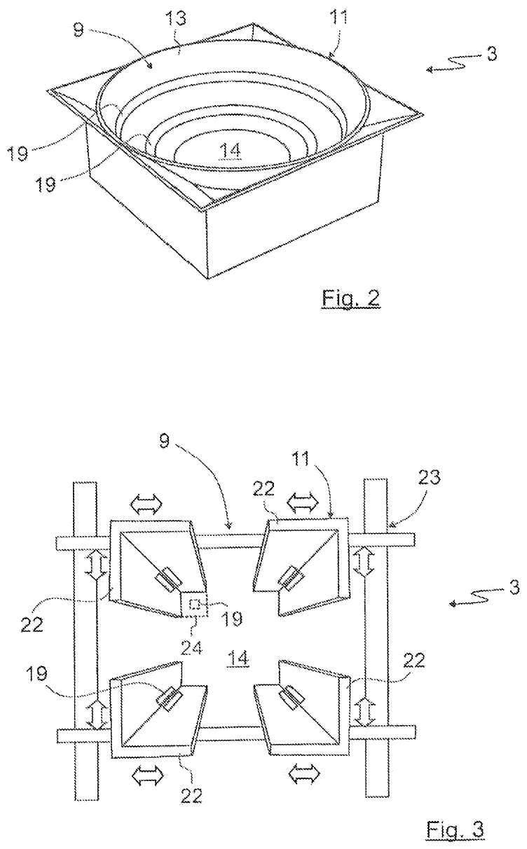

FIG. 3 shows a charging apparatus with a charging cradle in accordance with a third exemplary embodiment in a perspective illustration;

FIG. 4 shows a charging foot of a mobile electrical device in accordance with a second exemplary embodiment in a perspective illustration;

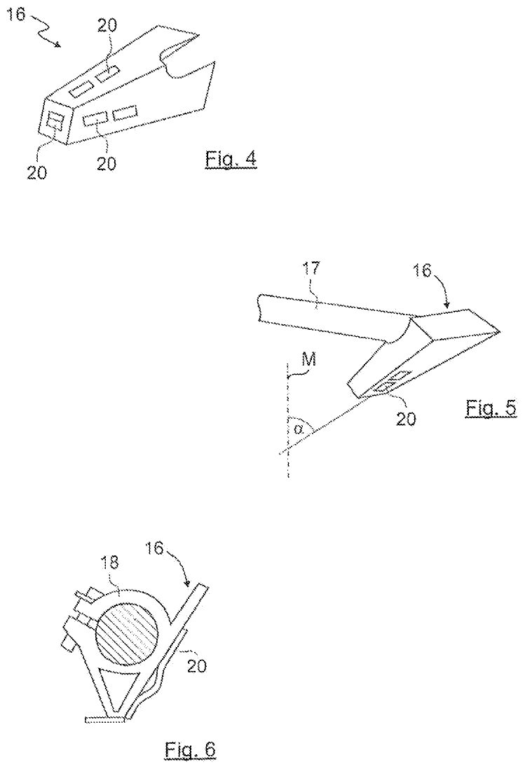

FIG. 5 shows a charging foot of a mobile electrical device in accordance with a third exemplary embodiment in a perspective illustration;

FIG. 6 shows an exemplary means of securing a charging foot to a mount of the mobile device in a sectional illustration;

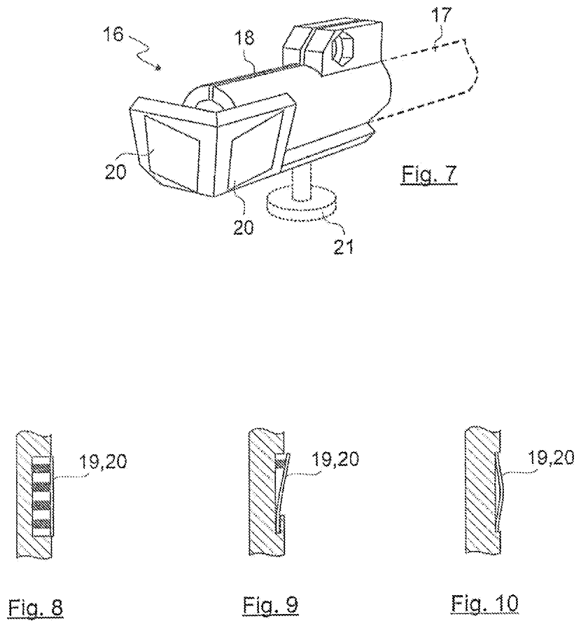

FIG. 7 shows the charging toot of the mobile electrical device from FIG. 1 in a perspective individual illustration;

FIG. 8 shows a spring-mounted contact element or respectively mating contact element in accordance with a first exemplary embodiment in a section illustration;

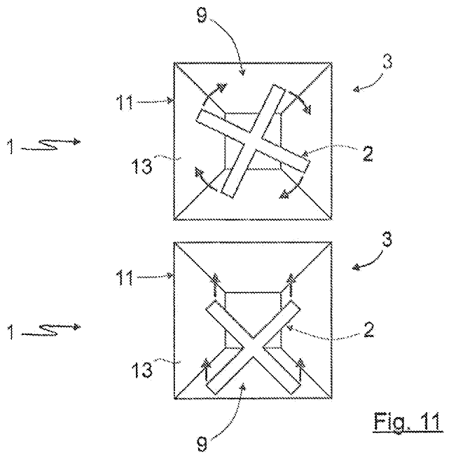

FIG. 9 shows a spring-mounted contact element or respectively mating contact element in accordance with a second exemplary embodiment in a section illustration;

FIG. 10 shows a spring-mounted contact element or respectively mating contact element in accordance with a third exemplary embodiment in a section illustration;

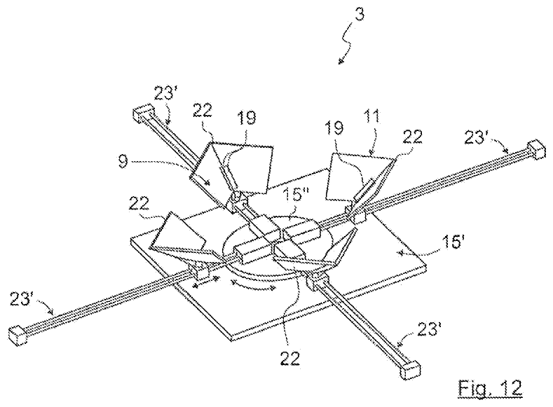

FIG. 11 shows the principle of the orientation of the mobile electrical device in the charging cradle in a plan view; and

FIG. 12 shows a charging apparatus with a charging cradle in accordance with a fourth exemplary embodiment in a perspective illustration.

FIG. 1 shows a charging system 1 with a mobile electrical device 2 and a charging apparatus 3 in accordance with a first exemplary embodiment of the invention.

In the exemplary embodiments, the mobile electrical device is embodied as an aircraft 2 or as an unmanned aircraft 2. In principle, however, the mobile electrical device can be an arbitrary mobile electrical device, for example also a mobile terminal such as a cellular phone or a tablet computer. Insofar as the mobile electrical device is referred to hereinafter as aircraft 2, this should not be understood to be restrictive, but rather is intended merely to afford a better understanding.

The unmanned aircraft 2 illustrated, colloquially also referred to as “drone”, is also illustrated merely schematically in order to clarify that the specific configuration of the aircraft 2 does not matter. The unmanned aircraft 2 is preferably embodied as a quadcopter with four electric motors 4, which drive respective propellers 5 (rotors/air screws) and are secured to corresponding cantilevers 6. In order to simplify the illustration, FIG. 1 illustrates just a single cantilever 6 with one electric motor 4 and an associated propeller 5.

The mobile device or the aircraft 2 comprises a rechargeable battery pack 7 and also a first controller 8 (indicated by dashed lines).

The charging system 1 according to the invention is used to charge the rechargeable battery pack 7 of the mobile device or of the aircraft 2 and/or to transfer data between the charging apparatus 3 and the mobile device or the aircraft 2. For this purpose, the charging apparatus 3 has an insertion opening 9 for inserting an insertion portion 10 of the mobile device or of the aircraft 2 into a charging cradle 11 of the charging apparatus 3, in order to establish the electrical connection between the charging apparatus 3 and the mobile device or the aircraft 2.

The specific orientation in particular of a landing aircraft 2 in a charging apparatus 3 for establishing a correct electrical connection is known to be problematic.

In principle, the charging apparatus 3 can have electrical, optical, acoustic or other markers in order to facilitate the approach of the aircraft 2 or in order to direct the aircraft 2 for the insertion of the insertion portion 10 as far as the insertion opening 9. For this purpose, in the exemplary embodiment, a light-emitting diode 12 is provided at each corner of the charging cradle 11. However, the insertion of the insertion portion 10 into the insertion opening 9 proves to be particularly problematic. In this regard, it is necessary to ensure that the aircraft 2 is corrected oriented for the subsequent establishment of the electrical connection. This is the starting point of the invention.

The invention provides for the charging cradle 11 to taper proceeding from the insertion opening 9 in order to automatically orient the insertion portion 10 of the mobile device or of the aircraft 2 during insertion into the charging cradle 11.

In the exemplary embodiment in accordance with FIG. 1, the charging cradle 11 has for this purpose four side walls 13 tapering pyramidally proceeding from the insertion opening 9. Furthermore, a cutout 14 is provided opposite the insertion opening 9. The cutout 14 can serve for example for guiding rainwater away if the charging cradle 11 is arranged outdoors. In addition, a baseplate 15 is also mounted below the cutout 14. The baseplate 15 can serve e.g. for better securing of the charging apparatus 3, for example on a vehicle or on a house roof. The cutout 14 and the baseplate 15 are each optional.

The insertion portion 10 of the aircraft 2 has four charging feet 16 secured to a landing gear 17 of the aircraft 2. In principle, any desired number of charging feet 16 can be provided, preferably corresponding to the number of corners of the charging cradle 11. Furthermore, as an alternative to being secured on the landing gear 17, the charging feet 16 can also be arranged on the cantilevers 6 for securing the propellers 5. The charging feet 16 can also be arranged vertically on the landing gear 17 or on the propellers 5. By way of example, two further securing positions are indicated by dashed lines in FIG. 1.

In the exemplary embodiment, the charging feet 16 are secured to the landing gear 17 in an extendable and rotatable manner (cf. arrows in FIG. 1). In this case, the securing can be effected e.g. by means of a clamping ring 18 using a machine screw, as illustrated in FIG. 6. One of the charging feet 16 in FIG. 1 is shown supplementarily in FIG. 7 in a perspective individual illustration.

The charging feet 16 are angled on their contact portion along an insertion angle α with respect to the center axis M of the charging cradle 11 (cf. FIG. 5), wherein the insertion angle α preferably corresponds to the taper angle β (cf. FIG. 1) according to which the charging cradle 11 tapers. The taper angle γ can optionally be adjustable, for example in order to enable an adaptation to different charging feet 16 with different insertion angles α.

If the aircraft 2 is then inserted into the charging cradle 11 through the insertion opening 9, it is able to correctly orient itself independently in the charging cradle 11 on account of the geometric shape according to the invention of the charging cradle 11, as is indicated in FIG. 11. The taper firstly results in a rotation of the aircraft 2 in such a way that the edges of the charging feet 16 finally engage with the respective corners of the charging cradle 11 (upper illustration in FIG. 11). At the same time the conical shape forces the aircraft 2 into the center of the charging cradle 11 on account of the weight force of the aircraft 2 (lower illustration in FIG. 11). At the same time a tilting of the aircraft 2 is also compensated for.

In the context of the invention, the charging cradle 11 and the insertion portion 10 form electrical contact element pairs comprising in each case a contact element 19 of the charging cradle 11 and a corresponding mating contact element 20 of the insertion portion 10.

In this case, the contact elements 19 of the charging cradle 11 are preferably arranged in a manner adjoining corners of two converging side walls 13, as is illustrated in FIGS. 1 and 3. In this case, each corner is assigned two contact elements 19, which are embodied as strip-shaped flat contacts in the exemplary embodiment. The corresponding mating contact elements 20 for forming the corresponding contact element pairs are arranged on the charging feet 16 in a manner adjoining an edge of two converging side surfaces, wherein one of the mating contact elements 20 is assigned to each of the two side surfaces. This is discernible particularly well in FIG. 7.

In order to prevent damage to the mating contact elements 20 of the charging feet 16 when the aircraft 2 is otherwise in operation, an optional landing foot 21 can supplementarily be provided, on which the aircraft 2 can land in the context of its conventional use (cf. dashed lines in FIG. 7).

In principle, an arbitrary distribution of the contact elements 19 and corresponding mating contact elements 20 can be provided such that they make electrical contact with one another correctly in the inserted and oriented state of the mobile device or of the aircraft 2. A further exemplary distribution of the mating contact elements 20 is discernible in FIGS. 4 and 5, which each show an alternative exemplary embodiment for the charging feet 16 of the mobile device or of the aircraft 2.

In principle, the contact elements 19 and/or mating contact elements 20 can be embodied as flat contacts, spring contacts and/or magnetically mounted contacts or other contacts. Particularly preferably, spring contacts are used, some exemplary variants being illustrated in FIGS. 8 to 10. FIG. 8 shows a flat contact mounted uniformly by a plurality of springs. FIG. 9 shows a flat contact that is spring-mounted on one side, and FIG. 10 shows a contact element 19 or respectively a mating contact element 20 in the manner of a leaf spring. In one preferred variant, mating contact elements 20 are spring-mounted and the contact elements 19 are embodied as flat contacts, in particular strip contacts.

In principle, the taper of the charging cradle 11 can be embodied in any desired fashion. For elucidation, FIG. 2 illustrates a further, exemplary variant for the embodiment of a charging cradle 11. The charging cradle 11 in FIG. 2 has a single, conically tapering side wall 13, which likewise has a cutout 14 situated opposite the insertion opening 9. The charging cradle 11 in accordance with FIG. 2 furthermore has contact elements 19 extending circumferentially in a ring-shaped fashion, since the illustrated conical variant of the invention does not allow rotative orientation of the mobile device or of the aircraft 2.

A further variant of a charging cradle 11 is illustrated in FIG. 3. The charging cradle 11 in FIG. 3 is formed from a plurality of side wall segments 22 forming respective corners, in a manner comparable with the variant in FIG. 1. Once again a cutout 14 is provided on the underside. As in the exemplary embodiment in FIG. 1, the contact elements 19 are arranged in the corners. On account of the segmented configuration, the charging cradle 11 in FIG. 3 is adaptable comparatively flexibly, particularly if the side wall segments 22 are arranged on a displaceable frame structure 23. In the case of a charging cradle 11 illustrated in FIG. 3, however, it may then be necessary for the mobile device or the aircraft 2 to be inserted into the charging cradle 11 already in a sufficiently accurately aligned rotational position, since the charging cradle 11 of the variant in FIG. 3 lacks the continuous side walls 13 that can serve for the initial guidance of the mobile device 2.

An arrangement of a contact element 19 on a charging surface 24 facing the insertion opening 9 is additionally indicated by dashed lines in FIG. 3. In principle, provision can be made for the contact elements 19 of the charging cradle 11 not to be arranged, or not to be exclusively arranged, on the side walls 13 or on the side wall segments 22. Consequently, one or a plurality of charging feet 16 can advantageously be seated on a charging surface 24. A correspondingly suitable mating contact element 20 is indicated in FIG. 4.

It should be mentioned that not all of the contact elements 19 or mating contact elements 20 need be electrically connected or present at all. In the context of the invention, provision can also be made of dummy contacts, for example dummy charging feet, too, which serve only for the orientation of the mobile device or of the aircraft 2 in the charging cradle 11.

A fourth exemplary embodiment of a charging apparatus 3 according to the invention is illustrated in FIG. 12. In a manner comparable with the exemplary embodiment described in FIG. 3, the charging cradle has four side wall segments 22 forming respective corners of the charging cradle 11. The contact elements 19 are arranged in the corners of the side wall segments 22.

The side wall segments 22 in FIG. 12 are also arranged displaceably in order that the charging cradle 11 is embodied adaptably for the insertion of different mobile devices or different aircraft 2. For this purpose, each of the side wall segments 22 is arranged on a dedicated guide rail 23′, wherein the guide rails 23′ are arranged in cruciform fashion around the center axis M of the charging cradle 11.

The charging apparatus 3 in FIG. 12 supplementarily comprises a rotation unit 15′ in order to set the rotational position of the charging cradle 11. As a result, the rotational position of the charging cradle 11 can advantageously be adaptable to the rotational position or orientation of the mobile device or of the aircraft 2. For this purpose, the side wall segments 22 are secured together with their guide rails 23′ on a rotatable rotary disk 15″.

Provision can be made for the charging apparatus 3 and/or the mobile device or the aircraft 2 to comprise a controller 8, 25 for controlling the charging process. By way of example, the first controller 8—indicated by dashed lines in FIG. 1—of the aircraft 2 can be used for this purpose. Furthermore, a second controller 25 of the charging apparatus 3 is likewise illustrated by dashed lines in FIG. 1. The controller(s) 8, 25 can be configured to detect a correct electrical connection between the mobile device or the aircraft 2 and the charging cradle 11, in order to initiate the charging process and/or the data transfer only in the case of the correct electrical connection. The second controller 25 of the charging apparatus 3 can be configured in particular to exchange data signals for controlling the charging process with a battery management system of the mobile electrical device or of the aircraft 2, for example for a compensatory regulation for uniform electrical charge distribution among a plurality of cells of the rechargeable battery pack 7.

Provision can also be made for at least one of the charging feet 16 to comprise a controller 26 (indicated in FIG. 1).

The controller 25 of the charging apparatus 3 can be configured to exchange data for the identification of the mobile device or of the aircraft 2 and/or for the acquisition of movement data (in particular flight data) of the mobile device or of the aircraft 2, in particular concerning position, orientation and/or tilt angle, of the mobile device or of the aircraft 2 wirelessly with the controller 8 of the mobile device or of the aircraft 2 and/or with the controller 26 of the charging foot 16. In particular, the controller 26 of the charging foot 16 can be communicatively connected to the controller 8 of the mobile device or of the aircraft for the exchange of data. For this purpose, the controller 26 of the charging foot 16 can for example be connected to a programming interface 27 of the mobile device or of the aircraft 2 and communicate defined control signals for communication with the controller 8. However, the controller 26 can for example also emulate a remote control of the mobile device or of the aircraft 2 or the control signals thereof. By way of example, the controller 26 can be configured to read out movement data (in particular Right data) of the mobile device or of the aircraft 2 from the controller 8 and/or to communicate to the controller 8 instructions for maneuvers to be carried out by the mobile device or by the aircraft 2 (for example a landing maneuver or a change of the rotational position).

1. A charging system comprising:
a mobile electrical device that has a rechargeable battery pack and an insertion portion;
a charging apparatus for charging the rechargeable battery pack of the mobile electrical device and/or for transferring data between the charging apparatus and the mobile electrical device, and wherein the charging apparatus has an insertion opening for inserting the insertion portion of the mobile electrical device into a charging cradle of the charging apparatus in order to establish an electrical connection between the charging apparatus and the mobile electrical device, characterized in that the charging cradle tapers proceeding from the insertion opening in order to orient the insertion portion of the mobile electrical device during insertion in the charging cradle; and wherein
the charging cradle has a plurality of side walls, tapering pyramidally proceeding from the insertion opening.

2. The charging system as claimed in claim 1, characterized in that the mobile electrical device is an aircraft, in particular an unmanned aircraft.

3. (canceled)

4. (canceled)

5. (canceled)

6. The charging system as claimed in claim 1, characterized in that the charging cradle and the insertion portion form electrical contact element pairs comprising in each case a contact element of the charging cradle and a corresponding mating contact element of the insertion portion.

7. (canceled)

8. The charging system as claimed in claim 1, characterized in that the contact elements of the charging cradle are arranged on the side walls and wherein the contact elements of the charging cradle are arranged in adjoining corners of two converging side walls, and wherein two contact elements are assigned to each corner.

9. (canceled)

10. (canceled)

11. (canceled)

12. (canceled)

13. The charging system as claimed in claim 1, characterized in that the insertion portion of the mobile electrical device has four charging feet.

14. The charging system as claimed in claim 13, characterized in that the four charging feet are angled along an insertion angle (α) or have a contact portion angled along an insertion angle (α).

15. The charging system as claimed in claim 13, characterized in that at least one of the mating contact elements is arranged on at least one of the four charging feet.

16. The charging system as claimed in claim 15, characterized in that two mating contact elements are arranged in a manner adjoining an edge of two converging side surfaces of the four charging feet, and wherein one of the mating contact elements is assigned to each of the two side surfaces.

17. (canceled)

18. The charging system (1) as claimed in claim 13, characterized in that the charging feet (16) are arranged on a landing gear (17) and/or on cantilevers (6) for securing propellers (5) of an aircraft (2).

19. (canceled)

20. The charging system as claimed in claim 1, characterized in that the charging apparatus has a rotation unit in order to set a rotational position of the charging cradle.

21. The charging system as claimed in claim 20, characterized in that the rotation unit has a rotary disk, which carries the side walls and is rotatable about a center axis (M) of the charging cradle.

22. The charging system as claimed in claim 1, characterized in that the charging apparatus and/or the mobile electrical device have/has a controller for controlling the charging process.

23. The charging system as claimed in claim 22, characterized in that the controller is configured to detect a correct electrical connection between the mobile electrical device and the charging cradle, and wherein the controller is configured to initiate the charging process and/or the data transfer only in the case of the correct electrical connection.

24. (canceled)

25. (canceled)

26. (canceled)

27. (canceled)

28. (canceled)

29. (canceled)

30. A charging apparatus for charging a rechargeable battery pack of a mobile electrical device and/or for transferring data between the charging apparatus and the mobile electrical device, comprising an insertion opening and a charging cradle, and wherein an insertion portion of the mobile electrical device is insertable into the charging cradle through the insertion opening in order to establish an electrical connection between the charging apparatus and the mobile electrical device, characterized in that the charging cradle tapers proceeding from the insertion opening in order to orient the insertion portion of the mobile electrical device during insertion in the charging cradle, and the charging cradle has a single side wall tapering conically proceeding from the insertion opening or has a plurality of side walls, tapering pyramidally proceeding from the insertion opening.

31. (canceled)

32. A charging method for charging a mobile electrical device in a charging apparatus, according to which the mobile electrical device independently orients itself on account of a geometric shape of a charging cradle of the charging apparatus in combination with an insertion portion of the mobile electrical device and thereby establishes an electrical connection between the charging apparatus and the mobile electrical device, according to which subsequently a charging process and/or a data transfer between the charging apparatus and the mobile electrical device are/is initiated, and wherein the charging cradle has a single side wall tapering conically proceeding from the insertion opening or has a plurality of side walls, tapering pyramidally proceeding from the insertion opening.

33. The charging method as claimed in claim 32, characterized in that the charging apparatus automatically adapts the size of the charging cradle to a size of the mobile electrical device and/or automatically adapts a rotational position of the charging cradle to an orientation of the mobile device.

34. (canceled)

35. A charging system, comprising:
a mobile electrical device that has a rechargeable battery pack and an insertion portion; and
a charging apparatus for charging the rechargeable battery pack of the mobile electrical device and/or for transferring data between the charging apparatus and the mobile electrical device, and wherein the charging apparatus has an insertion opening for inserting the insertion portion of the mobile electrical device into a charging cradle of the charging apparatus in order to establish an electrical connection between the charging apparatus and the mobile electrical device; and wherein
the charging cradle tapers proceeding from the insertion opening in order to orient the insertion portion of the mobile electrical device during insertion in the charging cradle, and wherein the charging cradle has a single side wall tapering conically proceeding from the insertion opening.

36. A charging system, comprising:
a mobile electrical device that has a rechargeable battery pack and an insertion portion; and
a charging apparatus for charging the rechargeable battery pack of the mobile electrical device and/or for transferring data between the charging apparatus and the mobile electrical device, and wherein the charging apparatus has an insertion opening for inserting the insertion portion of the mobile electrical device into a charging cradle of the charging apparatus in order to establish an electrical connection between the charging apparatus and the mobile electrical device; and wherein
the charging cradle has a plurality of side wall segments which form the respective corners of the charging cradle; and wherein
the plurality of side wall segments are arranged displaceably in the charging apparatus in order to embody the charging cradle adaptably for inserting different mobile electric devices.

37. The charging system as claimed in claim 36, characterized in that the charging cradle has a four side wall segments forming respective corners of the charging cradle.

38. The charging system as claimed in claim 37, characterized in that and the four side wall segments taper conically proceeding from the insertion opening.
